(19) United States
(12) Patent Application Publication
(10) Pub. No.: US 2014/0005039 A1
(43) Pub. Date: Jan. 2, 2014

(54) PROCESS FOR PREPARING CATALYST

(71) Applicant: SUMITOMO CHEMICAL COMPANY, LIMITED, Tokyo (JP)

(72) Inventors: Yoshihiko OHISHI, Osaka (JP); Anusorn Seubsai, Ladyao (TH); Selim Senkan, Los Angeles, CA (US)

(73) Assignee: SUMITOMO CHEMICAL COMPANY, LIMITED, Tokyo (JP)

(21) Appl. No.: 13/930,050

(22) Filed: Jun. 28, 2013

Related U.S. Application Data
(60) Provisional application No. 61/666,250, filed on Jun. 29, 2012.
(60) Provisional application No. 61/666,460, filed on Jun. 29, 2012.

(51) Int. Cl. B01J 37/08; B01J 27/13; B01J 27/25

(52) U.S. Cl. CPC B01J 37/08; B01J 27/25; B01J 27/13
USPC 502/201; 502/215; 502/226; 502/230

(57) ABSTRACT

A process for preparing a catalyst for production of an olefin oxide containing (a) a copper oxide and (b) a ruthenium oxide, which comprises the step of drying a mixture containing a copper component, a ruthenium component, water, and at least one ion selected from the group consisting of a nitrate ion having a molar ratio to the copper of 3 or more and a halide ion having a molar ratio to the ruthenium of 9 or more, and calcining.

### FIELD OF THE INVENTION

The present invention relates to a process for preparing a catalyst for production of an olefin oxide.

### BACKGROUND ART

As to a process for producing olefin oxides, olefin epoxidation in the presence of a metal-based catalyst has been proposed. For example, US2003/0191328 mentions a process for the epoxidation of hydrocarbon with oxygen in the presence of a mixture containing at least two metals from the specific metal group on a support having a specific BET surface area. JP2002-371074 mentions a process for producing an oxirane compound which process uses a metal oxide catalyst containing at least one metal selected from the metals belonging to the Groups III to XVI of the periodic table.

### SUMMARY OF THE INVENTION

The present invention provides:

[1] A process for preparing a catalyst for production of an olefin oxide containing (a) a copper oxide and (b) a ruthenium oxide, which comprises the step of drying a mixture containing a copper component, a ruthenium component, water, and at least one ion selected from the group consisting of a nitrate ion having a molar ratio to the copper of 3 or more and a halide ion having a molar ratio to the ruthenium of 9 or more, and calcining.
[2] A process for preparing a catalyst for production of an olefin oxide containing (a) a copper oxide, (b) a ruthenium oxide and (c) an alkaline metal component or alkaline earth metal component, which comprises the step of drying a mixture containing a copper component, a ruthenium component, an alkaline metal component or alkaline earth metal component, water, and at least one ion selected from the group consisting of a nitrate ion having a molar ratio to the copper of 3 or more and a halide ion having a molar ratio to the ruthenium of 9 or more, and calcining.
[3] A process for preparing a catalyst for production of an olefin oxide containing (a) a copper oxide, (b) a ruthenium oxide, (c) an alkaline metal component or alkaline earth metal component and (d) a tellurium oxide, which comprises the step of drying a mixture containing a copper component, a ruthenium component, an alkaline metal component or alkaline earth metal component, a tellurium component, water, and at least one ion selected from the group consisting of a nitrate ion having a molar ratio to the copper of 3 or more and a halide ion having a molar ratio to the ruthenium of 9 or more, and calcining.
[4] The process according to [1], wherein the mixture contains a support.
[5] The process according to [2], wherein the mixture contains a support.
[6] The process according to [3], wherein the mixture contains a support.
[7] The process according to [4], [5] or [6], wherein the support contains Al₂O₃, SiO₂, TiO₂ or ZrO₂.
[8] The process according to [4], [5] or [6], wherein the support contains SiO₂.
[9] The process according to [1], [2] or [3], wherein the ruthenium/copper molar ratio in the catalyst is 0.01/1 to 50/1.
[10] The process according to [2] or [3], wherein the alkaline metal or alkaline earth metal/copper molar ratio in the catalyst is 0.001/1 to 50/1.
[11] The process according to [3], wherein the tellurium/copper molar ratio in the catalyst is 0.001/1 to 50/1.
[12] The process according to [1], [2] or [3], wherein the component (a) is CuO.
[13] The process according to [1], [2] or [3], wherein the component (b) is RuO₂.
[14] The process according to [2] or [3], wherein the component (c) is an alkaline metal-containing compound.
[15] The process according to [14], wherein the alkaline metal-containing compound is a sodium-containing compound or a potassium-containing compound.
[16] The process according to [3], wherein the component (d) contains tellurium and an oxygen atom.
[17] The process according to [4], [5] or [6], wherein the total amount of the components (a) and (b) is 0.01 to 80 weight parts relative to 100 weight parts of the support.
[18] The process according to [1], [2] or [3], wherein the ion is nitrate ion and the nitrate ion/copper molar ratio is 3 to 50 based on their atoms.
[19] The process according to [1], [2] or [3], wherein the ion is halide ion and the halide ion/ruthenium molar ratio is 9 to 50 based on their atoms.
[20] The process according to [1], [2] or [3], wherein the ion is halide ion and the halide ion is Cl⁻.
[21] A catalyst for production of an olefin oxide containing (a) a copper oxide and (b) a ruthenium oxide, which is obtained by a preparation method comprising the step of drying a mixture containing a copper component, a ruthenium component, water, and at least one ion selected from the group consisting of a nitrate ion having a molar ratio to the copper of 3 or more and a halide ion having a molar ratio to the ruthenium of 9 or more, and calcining.
[22] A catalyst for production of an olefin oxide containing (a) a copper oxide, (b) a ruthenium oxide and (c) an alkaline metal component or alkaline earth metal component, which is obtained by a preparation method comprising the step of drying a mixture containing a copper component, a ruthenium component, an alkaline metal component or alkaline earth metal component, water, and at least one ion selected from the group consisting of a nitrate ion having a molar ratio to the copper of 3 or more and a halide ion having a molar ratio to the ruthenium of 9 or more, and calcining.
[23] A catalyst for production of an olefin oxide containing (a) a copper oxide, (b) a ruthenium oxide, (c) an alkaline metal component or alkaline earth metal component and (d) a tellurium oxide, which is obtained by a preparation method comprising the step of drying a mixture containing a copper component, a ruthenium component, an alkaline metal component or alkaline earth metal component, a tellurium component, water, and at least one ion selected from the group consisting of a nitrate ion having a molar ratio to the copper of 3 or more and a halide ion having a molar ratio to the ruthenium of 9 or more, and calcining.

### DETAILED DESCRIPTION OF THE INVENTION

The present invention comprises a process for preparing a catalyst containing the step of drying a mixture containing a copper component, a ruthenium component, water, and at least one ion selected from the group consisting of a nitrate ion having a molar ratio to the copper of 3 or more and a halide ion having a molar ratio to the ruthenium of 9 or more, and calcining.

The prepared catalyst containing (a) a copper oxide and (b) a ruthenium oxide is valuable for production of olefin oxide with good selectivity and productivity (e.g. space time yield).

In the catalyst, the components (a) and (b) are preferably supported on a support, more preferably supported on a porous support. Examples of the non-porous support include a non-porous support comprising SiO₂ such as CAB-O-SIL (registered trademark). This catalyst is valuable for production of olefin oxides, which is one aspect of the present invention.

The porous support has pores capable of supporting the components (a) and (b). The porous support comprises preferably Al₂O₃, SiO₂, TiO₂, or ZrO₂, more preferably SiO₂. Examples of the porous support comprising SiO₂ include mesoporous silica. Such a porous support may also comprise zeolites.

The support may be in form of powder, or shaped to a desired structure as necessary.

If the catalyst comprises SiO₂ as a support, olefin oxides can be produced with good yield and selectivity.

The component (a) is usually composed of copper and oxygen. Examples of the copper oxide include Cu₄O₃, Cu₂O and CuO. The copper oxide is preferably CuO.

The catalyst may contain one or more kinds of the component (b). The component (b) is usually composed of ruthenium and oxygen. Examples of the ruthenium oxide include Ru₂O₄, Ru₂O₅, Ru₃O₅, Ru₃O₆, RuO₄, and RuO₂, preferably RuO₂.

The catalyst may contain one or more kinds of (c) an alkaline metal component or alkaline earth metal component. In the catalyst, the component (c) may be supported on the above-mentioned support, or the components (a) and (b).

The component (c) may be an alkaline metal-containing compound, an alkaline earth metal-containing compound, an alkaline metal ion or an alkaline earth metal ion.

Examples of the alkaline metal-containing compound include compounds containing an alkaline metal such as Na, K, Rb and Cs. Examples of the alkaline earth metal-containing compound include compounds containing an alkaline earth metal such as Mg, Ca, Sr and Ba. Examples of the alkaline metal ion include Na⁺, K⁺, Rb⁺ and Cs⁺. Examples of the alkaline earth metal ion include such as Me²⁺, Ca²⁺, Sr²⁺ and Ba²⁺.

The alkaline metal component may be an alkaline metal oxide. Examples of the alkaline metal oxide include Na₂O, Na₂O₂, K₂O, K₂O₂, Rb₂O, Rb₂O₂, Cs₂O, and Cs₂O₂. The alkaline earth metal component may be alkaline earth metal oxide. Examples of the alkaline earth metal oxide include CaO, CaO₂, MgO, MgO₂, SrO, SrO₂, BaO and BaO₂.

The component (c) is preferably an alkaline metal-containing compound, more preferably a sodium-containing compound or a potassium-containing compound, still more preferably a sodium-containing compound.

The alkaline metal-containing compound and alkaline earth metal-containing compound are preferably an alkaline metal salt and an alkaline earth metal salt. The alkaline metal salt contains the alkaline metal ion as mentioned above with an anion. The alkaline earth metal salt contains the alkaline earth metal ion as mentioned above with an anion. Examples of anions in such salts include Cl⁻, Br⁻, I⁻, F⁻, OH⁻, NO₃⁻, SO₄²⁻ and CO₃²⁻. Such salts are preferably an alkaline metal salt with a halogen, such as an alkaline metal halide, or an alkaline earth metal-containing salt with a halogen, such as an alkaline earth metal halide, more preferably an alkaline metal salt with a halogen, still more preferably an alkaline metal chloride.

The catalyst may contain one or more kinds of (d) a tellurium component. The component (d) may be tellurium-containing compound or tellurium ion. Examples of the tellurium-containing compound include tellurium oxide such as TeO, TeO₂, TeO₃, Te₂O₅, or Te₄O₉ and tellurium salt with anion such as Cr, Br⁻, I⁻, F⁻, OH⁻, NO³⁻ or CO₃²⁻. Examples of the tellurium ion include Te²⁺, Te⁴⁺, Te⁶⁺, Te²⁻. The component (d) is preferably tellurium oxide, more preferably those composed of tellurium and an oxygen atom, still more preferably TeO₂.

The catalyst contains preferably CuO and RuO₂, more preferably CuO, RuO₂, and an alkaline metal-containing compound, or CuO, RuO₂, an alkaline metal-containing compound and Te component, still more preferably CuO, RuO₂, a sodium-containing compound and Te component, because the olefin oxide yield and selectivity can be improved by adopting such combination to the production of an olefin oxide. Particularly if the catalyst contains NaCl, as the component (c), it can show excellent olefin oxide selectivity. Herein, the catalysts generally contain no silver element, which can be prepared without silver metal or silver-containing compounds.

The ruthenium/copper molar ratio in the catalyst is preferably 0.01/1 to 50/1 based on their atoms. When the molar ratio falls within such a range, the olefin oxide yield and selectivity can be further improved. The lower limit of the molar ratio is more preferably 0.1/1, still more preferably 0.15/1, most preferably 0.2/1. The upper limit of the molar ratio is more preferably 5/1, still more preferably 2/1, most preferably 1/1.

The alkaline metal or alkaline earth metal/copper molar ratio in the catalyst is preferably 0.001/1 to 50/1 based on their atoms. When the molar ratio falls within such a range, the olefin oxide yield and selectivity can be further improved. The lower limit of the molar ratio is more preferably 0.01/1, still more preferably 0.1/1. The upper limit of the molar ratio is more preferably 10/1, still more preferably 5/1. The “component (c)” of the molar ratio represents the total molar ratio of the alkaline metal or alkaline earth metal existing in the component (c) and the alkaline metal or alkaline earth metal ion existing in the component (c).

The tellurium/copper molar ratio in the catalyst is preferably 0.001/1 to 50/1 based on their atoms. When the molar ratio falls within such a range, the olefin oxide yield and selectivity can be further improved. The lower limit of the molar ratio is more preferably 0.01/1, still more preferably 0.05/1. The upper limit of the molar ratio is more preferably 1/1, still more preferably 0.5/1.

If the catalyst contains the other metal(s) like V, Mo or W, V, Mo or W, these metal(s)/ruthenium molar ratio in the catalyst is preferably less than 0.24, more preferably less than 0.1, still more preferably 0.

When the components (a) and (b), and optionally any of the components (c) and (d) are supported on a support in the catalyst, the total content of these components is preferably 0.01 to 80 weight parts relative to 100 weight parts of a support. When the total content falls within such a range, the olefin oxide yield and selectivity can be further improved. The lower limit of the total content is more preferably 0.05 weight parts, still more preferably 0.1 weight parts relative to 100 weight parts of a support. The upper limit of the total content is more preferably 50 weight parts, still more preferably 30 weight parts relative to 100 weight parts of the support.

The catalyst may contain (e) halogen component besides the components (a), (b), (c) and (d). The component (e) is generally a halogen-containing compound. Examples of the halogen include chlorine, fluorine, iodine and bromine.

Examples of such a halogen-containing compound include copper halides such as CuCl and CuCl₂, tellurium halides such as TeCl₂ and TeCl₄, ruthenium halides such as RuCl₃ and copper oxyhalides such as CuOCl₂, CuClO₄, ClO₂Cu(ClO₄)₃ and Cu₂O(ClO₄)₂, tellurium oxyhalides such as Te₆O₂₁Cl₂₂, ruthenium oxyhalides such as Ru₂OCl₄, Ru₂OCl₅ and Ru₂OCl₆. If the catalyst contains the component (e), the component may be supported on any of the components (a), (b) (c) and (d) or the support.

The catalyst may further contain (f) composite oxides including those composed of copper, tellurium and oxygen, such as CuTeO₄, CuTeO₃ and Cu₃TeO₆, those composed of tellurium, sodium and oxygen, such as Na₂TeO₃, Na₂TeO₄, Na₂Te₄O₉, and Na₄TeO₅, and those composed of sodium, copper and oxygen, such as NaCuO₂, Na₂CuO₂, NaCuO and Na₆Cu₂O₆, those composed of ruthenium, tellurium and oxygen, those composed of ruthenium, copper and oxygen such as RuCu₂O₂, RuCuClO₃, Ru₂CuO₆, Ru₂Cu₂O₂, and those composed of ruthenium, sodium and oxygen.

If the catalyst contains the component (f), the component may be supported on the support or any of the components (a), (b), (c), (d) and (e) as mentioned above.

Production of the catalyst is not restricted to a specific process, examples of which include the conventional methods, for example, impregnation method, precipitation method, deposition precipitation, chemical vapour deposition, mechnano-chemical method, solid state reaction method, hydrothermal synthesis and the like, preferably impregnation method.

When the components (a) and (b), optionally in addition with the component (c), (d), (e) or (f), are supported on a support in the catalyst, the catalyst can be obtained by impregnating the support with a solution containing a copper ion, a ruthenium ion, and optionally an alkaline metal or alkaline earth metal-containing ion, a tellurium compound or ion and/or a halogen ion to prepare a composition, followed by calcining the composition. The support can be in form of powder, or shaped to a desired structure as necessary.

The solution containing above-mentioned ions can be prepared by dissolving a copper metal salt, a ruthenium metal salt, and optionally an alkaline metal or alkaline earth metal-containing salt, a tellurium metal salt and/or a halogen-containing compound, and a nitrate ion (NO₃⁻) and/or a halide ion in a solvent. Examples of halide ion include F⁻, Cl⁻, Br⁻ and I⁻, preferably Cl⁻.

The nitrate ion/copper molar ratio is preferably 3 to 50 based on their atoms. When the molar ratio falls within such a range, the olefin oxide yield and olefin conversion can be further improved. The lower limit of the molar ratio is more preferably 3.5, still more preferably 5. The upper limit of the molar ratio is more preferably 30, still more preferably 15.

The source materials of a nitrate ion are not limited, preferably one or more selected from nitric acid, and nitrates such as ammonium nitrate, and metal nitrates described below, for example, copper nitrate, ruthenium nitrate, or alkaline metal or alkaline earth metal nitrates.

The halide ion/ruthenium molar ratio is preferably 9 to 50 based on their atoms. When the molar ratio falls within such a range, the olefin oxide yield and selectivity can be further improved. The lower limit of the molar ratio is more preferably 12, still more preferably 16. The upper limit of the molar ratio is more preferably 30, still more preferably 25.

The source materials of a halide ion are not limited, preferably one or more selected from hydrogen halides such as HF, HCl, HBr and HI, and ammonium halides such as NH₄F, NH₄Cl, NH₄Br and NH₄I, and metal salt containing halogen, for example, copper salt containing halogen, ruthenium salt containing halogen, alkaline metal or alkaline earth metal salt containing halogen, and tellurium salt containing halogen described below, more preferably hydrogen chloride, ammonium chloride, and metal salt containing chloride such as copper salt containing chloride, ruthenium salt containing chloride, alkaline metal or alkaline earth metal salt containing chloride, and tellurium salt containing chloride described below.

Examples of the copper salt include, for example, copper ammonium chloride, copper bromide, copper carbonate, copper ethoxide, copper hydroxide, copper iodide, copper isobutyrate, copper isopropoxide, copper oxalate, copper oxychloride, copper oxide, copper nitrates, and copper chlorides, preferably copper nitrates and copper chlorides.

Examples of the ruthenium metal salt include, for example, a halide such as ruthenium bromide, ruthenium chloride, ruthenium iodide, an oxyhalide such as Ru₂OCl₄, Ru₂OCl₅ and Ru₂OCl₆, a halogeno complex such as [RuCl₂(H₂O)₄]Cl, an amine complex such as [Ru(NH₃)₅H₂O]Cl₂, [Ru(NH₃)₅Cl]Cl₂, [Ru(NH₃)₆]Cl₂ and [Ru(NH₃)₆]Cl₃, a carbonyl complex such as Ru(CO)₅ and Ru₃(CO)₁₂, a carboxylate complex such as [Ru₃O(OCOCH₃)₆(H₂O)₃], ruthenium nitrosylchloride, [Ru₂(OCOR)₄]Cl (R=alkyl group having 1 to 3 carbon atoms), a nitrates such as Ru (NO₃)₃, a nitrosyl complex such as [Ru (NH₃)₅(NO)]Cl₃, [Ru (OH)(NH₃)₄(NO)](NO₃)₂ and [Ru(NO)](NO₃)₃, an amine complex, an acetylacetonate complex, an oxide such as RuO₂, and ammonium salt such as (NH₄)₂RuCl₆, preferably ruthenium metal salt containing Cl.

The alkaline metal or alkaline earth metal salt for the solution may be the same as or different from the component (d). Examples of the alkaline metal salt and the alkaline earth metal salt include alkaline metal nitrates, alkaline earth metal nitrates, alkaline metal halides, alkaline earth metal halides, alkaline metal acetates, alkaline earth metal acetates, alkaline metal butyrates, alkaline earth metal butyrates, alkaline metal benzoates, alkaline earth metal benzoates, alkaline metal alkoxides, alkaline earth metal alkoxides, alkaline metal carbonates, alkaline earth metal carbonates, alkaline metal citrates, alkaline earth metal citrates, alkaline metal formates, alkaline earth metal formates, alkaline metal hydrogen carbonates, alkaline earth metal hydrogen carbonates, alkaline metal hydroxides, alkaline earth metal hydroxides, alkaline metal hypochlorites, alkaline earth metal hypochlorites, alkaline metal halates, alkaline earth metal halates, alkaline metal nitrites, alkaline earth metal nitrites, alkaline metal oxalates, alkaline earth metal oxalates, alkaline metal perhalates, alkaline earth metal perhalates, alkaline metal propionates, alkaline earth metal propionates, alkaline metal tartrates and alkaline earth metal tartrates, preferably alkaline metal halides and alkaline metal nitrates, more preferably NaNO₃ and NaCl.

Examples of the tellurium compound or salt include, for example, a halide such as TeF₆, TeBr₄, TeCl₄ and TeI₄, an oxyhalide, oxide such as TeO, TeO₂ and TeO₃, an alkoxide such as Te(OC₂H₅)₄, a tellurate such as H₂TeO₃, H₆TeO₆, Na₂TeO₃, (NH₄)₂TeO₄ and Na₂TeO₄, preferably halide and oxide, more preferably oxide, still more preferably TeO₂.

At least one of the metal salts for the solvent contains preferably a halogen ion, more preferably a chloride ion.

If an alkaline metal salt or alkaline earth metal salt with a halogen is used for production of the catalyst, the catalyst comprising the components (a), (b), (c), (d) and (e) can be produced from a solution obtained by dissolving the copper metal salt, the tellurium metal salt and the alkaline metal salt or alkaline earth metal salt in a solvent. At least one of the metal salts for the solvent contains preferably a halogen ion, more preferably a chloride ion. Such a halogen ion may form the component (c) such as NaCl and the component (e) such as halides and oxyhalides of Cu, Ru or Te.

Examples of the solvent for the solution include water, alcohols such as methanol or ethanol, and ethers, preferably water. As a source of water, ion-exchanged water is usually used. The amount of water, alcohols or ethers as the solvent is not limited, preferably 0.01 part to 2000 parts by weight per 1 part by weight of copper in the mixture. If the catalyst contains support, the amount of water, alcohols or ethers as the solvent is preferably 0.01 part to 500 parts by weight per 1 part by weight of support in the mixture, more preferably 0.1 part to 100 parts by weight per 1 part by weight of support in the mixture.

The slurry composed of metal salts described above or support is preferably aged with stirring at a temperature of 5° C. to 100° C., more preferably 10° C. to 50° C. The slurry can be used as is, but is preferably aged for some time. Aging time is preferably in the range from 0.5 hour to 48 hours, more preferably 1 hour to 25 hours.

The composition as prepared by the impregnation is usually dried, and the drying method thereof is not limited. For example, evaporation to dryness, spray drying, drum drying, flash drying and the like. The composition is preferably dried at a temperature of 10° C. to 250° C., more preferably 40° C. to 200° C., before calcining the composition. Drying may be performed under an atmosphere of air or also under an inert gas atmosphere (for example, Ar, N₂, He) at standard pressure or reduced pressure. A drying time is preferably in the range from 0.5 hour to 24 hours. After drying, the composition can be shaped to a desired structure as necessary.

Calcining the composition is not limited, but preferably may be performed under a gas atmosphere containing oxygen and/or inert gas such as nitrogen, helium and argon. Examples of such a gas include air, an oxygen gas, nitrous oxide, and other oxidizing gases. The gas may be used after being mixed at an appropriate ratio with a diluting gas such as nitrogen, helium, argon, and water vapor. An optimal temperature for calcination varies depending on the kind of the gas and the composition, however, a too high temperature may cause agglomeration of copper and ruthenium components. Accordingly, the calcination temperature is typically 250° C. to 800° C., preferably 400° C. to 600° C. The calcining time is preferably in the range from 0.5 hour to 24 hours.

The catalyst can be used as powder, but it is usual to shape it into desired structures such as spheres, pellets, cylinders, rings, hollow cylinders or stars. The catalyst can be shaped by a known procedure such as extrusion, ram extrusion, tableting. The calcination is normally performed after shaping into the desired structures, but it can also be performed before shaping them.

Next, the following explains a reaction of an olefin with oxygen in the presence of the catalyst as described above.

In the present invention, the olefin may have a linear or branched structure and contains usually 2 to 10, preferably 2 to 8 carbon atoms. The olefin may be a monoolefin or a diolefin. Examples of the monoolefin include ethylene, propylene, butene, pentene, hexene, heptene, octene, nonene, and decene. Examples of the diene include butadiene such as 1,3-butadiene or 1,2-butadiene. Examples of the olefin include preferably monoolefin, more preferably ethylene, propylene, butene, pentene, hexene, heptene and octene, still more preferably ethylene, propylene and butene, most preferably propylene.

The reaction is generally performed in the gas phase. In the reaction, the olefin and oxygen may be fed respectively in the form of a gas. Olefin and oxygen gases can be fed in the form of their mixed gas. Olefin and oxygen gases may be fed with diluent gases. Examples of diluent gases include nitrogen, methane, ethane, propane, carbon dioxide, or rare gases, such as argon and helium.

As the oxygen source, pure oxygen may be used, or a mixed gas containing a gas inactive to the reaction, such as air, may be used. The amount of oxygen used varies depending on the reaction type, the catalyst, the reaction temperature or the like. The amount of oxygen is typically 0.01 mol to 100 mol, and preferably 0.03 mol to 30 mol, and more preferably 0.05 mol to 10 mol, with respect to 1 mol of the olefin.

The reaction is performed at a temperature generally of 100° C. to 350° C., preferably of 120° C. to 330° C., more preferably of 170° C. to 310° C.

The reaction is usually carried out under reaction pressure in the range of reduced pressure to increased pressure. By carrying out the reaction under such a reaction pressure condition, the productivity and selectivity of olefin oxides can be improved. Reduced pressure means a pressure lower than atmospheric pressure. Increased pressure means a pressure higher than atmospheric pressure. The pressure is typically in the range of 0.01 MPa to 3 MPa, and preferably in the range of 0.02 MPa to 2 MPa, in the absolute pressure.

The gaseous hourly space velocity (Liters of gas at standard temperature and pressure passing over the one liter of packed catalyst per hour) is generally in the range of from 100 Nl/(l·h) to 100000 Nl/(l·h), preferably 500 Nl/(l·h) to 50000 Nl/(l·h). The linear velocity is generally in the range of from 0.0001 m/s to 500 m/s, and preferably in range of 0.001 m/s to 50 m/s.

The reaction may be carried out as a batch reaction or a continuous flow reaction, preferably as a continuous flow reaction for industrial application. The reaction of the present invention may be carried out by mixing an olefin and oxygen and then contacting the mixture with the catalyst under reduced pressure to the increased pressure.

The reactor type is not limited. Examples of the reactor type are fluid bed reactor, fixed bed reactor, moving bed reactor, and the like, preferably fixed bed reactor. In the case of using fixed bed reactor, single tube reactor or multi tube reactor can be employed. More than one reactor can be used. If the number of reactors is large, small reactors as for example microreactors, can be used, which can have multiple channels.

In the case of using fixed bed reactor, the catalyst can be packed into a reactor or coated on the surface of the reactor wall. The coated type reactor is suitable for microreactors and the packed bed reactor is suitable for large reactor.

Generally, the reaction mixture can be passed through the packed bed reactor in up-flow mode or in downflow mode.

Adiabatic type reactor or heat exchange type reactor may also be used. In the case of using adiabatic type reactor, part of reaction mixture from reactor can be recycled into the reactor after heat-exchanging to control the reaction temperature.

In the case of using at least two reactors, the reactors can be arranged in series and/or in parallel. In the case of using at least two reactors arranged in series, a heat exchanger can be used between the reactors for controlling reaction temperature.

In the present invention, the olefin oxide may have a linear or branched structure and contains usually 2 to 10, preferably 2 to 8 carbon atoms. The olefin oxide may have one carbon-carbon double bond when the diolefin is applied for the reaction. Examples of the olefin oxide having one carbon-carbon double bond include 3,4-epoxy-1-butene. Examples of the olefin oxides include preferably ethylene oxide, propylene oxide, butene oxide, pentene oxide, hexene oxide, heptene oxide and octene oxide, more preferably ethylene oxide, propylene oxide and butene oxide, still more preferably propylene oxide.

The olefin oxide as obtained can be collected by a method known in the art such as absorption with a suitable solvent as water, acetonitrile and the like, and subsequent a method known in the art such as separation by distillation.

### EXAMPLES

In Examples A1 to A4, B1 and B2 and Comparative Example A-1 and B-1, each measurement was performed according to the following method:

A reaction gas was mixed with ethane (10 Nml/min) as an external standard, and then directly introduced in the TCD-GC equipped with a column of Gaskuropack 54 (2 m). All products in the reaction gas were collected for 1 hour with double methanol traps connected in series and cooled with an ice bath. The two methanol solutions were mixed together and added to anisole as an external standard, and then analyzed with two FID-GCs equipped with different columns, PoraBOND U (25 m) and PoraBOND Q (25 m).

The detected products were propylene oxide (PO), acetone (AT), COₓ (CO₂ and CO), propanal (PaL) and acrolein (AC).

Propylene conversions (X_{PR}) were determined from the following:

X_{PR}={[PO+AC+AT+PaL+CO₂/3]ₒᵤₜ/[C₃H₆]ᵢₙ}×100%;

and PO selectivities (S_{PO}) were then calculated using the following expression:

S_{PO}{[PO]/[PO+AC+AT+PaL+CO₂/3]}×100%

Space time yield (STY) were also determined from the following:

STY=[PP](μmol/h)/Catalyst(ml)

Each metal weight was determined from the amounts of the metal salts used for preparation of catalyst.

### Example A-1

A catalyst was prepared by a co-impregnation method. A predetermined weights (1.9 g) of an amorphous silica powder (SiO₂, Japan Aerosil, 380 m²/g) was added to an aqueous solution mixture containing 0.22 g of (NH₄)₂RuCl₆ (Alfa), 0.30 g of Cu(NO₃)₂ (Wako), 0.025 g of TeO₂ (Wako), 0.1 g of NaCl (Wako), 0.11 g of 69% HNO₃ and 40 g of ion-exchanged water, followed by stirring it for 24 hours at room temperature in the air to impregnate the support with the metal salts. The resulting material was then heated at 100° C. until dried, and calcined at 500° C. for 12 hours in the air to give a catalyst.

The catalyst was evaluated by using a fixed-bed reactor. Filling a ½-inch reaction tube made of stainless steel with 1 mL of thus obtained catalyst, the reaction tube was supplied with 450 NmL/h of propylene, 900 NmL/h of the air, 990 NmL/h of a nitrogen gas to carry out the reaction at the reaction temperature of 270° C. under the condition of the increased pressure (equivalent to 0.3 MPa in the absolute pressure).

In the catalyst, NO₃⁻/Cu molar ratio was 3, and the total amount of Cu, Te, Ru and Na was 10.4 weight parts relative to 100 weight parts of SiO₂.

The results are shown in Table A-1.

TABLE A-1

| | |
|---|---|
| NO₃⁻/Cu (molar ratio) | 3 |
| Cu/Te/Ru/Na (molar ratio of metal) | 1/0.1/0.5/1.4 |
| Propylene conversion (%) | 4.4 |
| Propylene oxide selectivity (%) | 40 |
| STY (μmol-PO/ml-cat · h) | 360 |

### Example A-2

A catalyst was prepared in the same condition as Example A-1 except using 0.23 g of 69% HNO₃ instead of 0.11 g of 69% HNO₃.

In the catalyst, NO₃⁻/Cu molar ratio was 4, and the total amount of Cu, Te, Ru and Na was 10.4 weight parts relative to 100 weight parts of SiO₂.

The catalyst was evaluated in the same manners as Example A-1. The results are shown in Table A-2.

TABLE A-2

| | |
|---|---|
| NO₃⁻/Cu (molar ratio) | 4 |
| Cu/Te/Ru/Na (molar ratio of metal) | 1/0.1/0.5/1.4 |
| Propylene conversion (%) | 5.1 |
| Propylene oxide selectivity (%) | 41 |
| STY (μmol-PO/ml-cat · h) | 415 |

### Example A-3

A catalyst was prepared in the same condition as Example A-1 except using 0.45 g of 69% HNO₃ instead of 0.11 g of 69% HNO₃.

In the catalyst, NO₃⁻/Cu molar ratio was 6, and the total amount of Cu, Te, Ru and Na was 10.4 weight parts relative to 100 weight parts of SiO₂.

The catalyst was evaluated in the same manners as Example A-1. The results are shown in Table A-3.

TABLE A-3

| | |
|---|---|
| NO₃⁻/Cu (molar ratio) | 6 |
| Cu/Te/Ru/Na (molar ratio of metal) | 1/0.1/0.5/1.4 |
| Propylene conversion (%) | 6.1 |
| Propylene oxide selectivity (%) | 42 |
| STY (μmol-PO/ml-cat · h) | 537 |

### Example A-4

A catalyst was prepared in the same condition as Example A-1 except using 0.91 g of 69% HNO₃ instead of 0.11 g of 69% HNO₃.

In the catalyst, NO₃⁻/Cu molar ratio was 10, and the total amount of Cu, Te, Ru and Na was 10.4 weight parts relative to 100 weight parts of SiO₂.

The catalyst was evaluated in the same manners as Example A-1. The results are shown in Table A-4.

TABLE A-4

| | |
|---|---|
| NO₃⁻/Cu (molar ratio) | 10 |
| Cu/Te/Ru/Na (molar ratio of metal) | 1/0.1/0.5/1.4 |
| Propylene conversion (%) | 6.8 |
| Propylene oxide selectivity (%) | 39 |
| STY (μmol-PO/ml-cat · h) | 527 |

### Example B-1

A catalyst was prepared by a co-impregnation method. A predetermined weights (1.9 g) of an amorphous silica powder (SiO₂, Japan Aerosil, 380 m²/g) was added to an aqueous solution mixture containing 0.22 g of (NH₄)₂RuCl₆ (Alfa), 0.30 g of Cu(NO₃)₂ (Wako), 0.025 g of TeO₂(Wako), 0.1 g of NaCl (Wako), 0.26 g of 35% HCl and 40 g of ion-exchanged water, followed by stirring it for 24 hours at room temperature in the air to impregnate the support with the metal salts. The resulting material was then heated at 100° C. until dried, and calcined at 500° C. for 12 hours in the air to give a catalyst.

The catalyst was evaluated by using a fixed-bed reactor. Filling a ½-inch reaction tube made of stainless steel with 1 mL of thus obtained catalyst, the reaction tube was supplied with 450 NmL/h of propylene, 900 NmL/h of the air, 990 NmL/h of a nitrogen gas to carry out the reaction at the reaction temperature of 270° C. under the condition of the increased pressure (equivalent to 0.3 MPa in the absolute pressure).

In the catalyst, Cl⁻/Ru molar ratio was 12.8, and the total amount of Cu, Te, Ru and Na was 10.4 weight parts relative to 100 weight parts of SiO₂.

The results are shown in Table B-1.

TABLE B-1

| | |
|---|---|
| Cl⁻/Ru (molar ratio) | 12.8 |
| Cu/Te/Ru/Na (molar ratio of metal) | 1/0.1/0.5/1.4 |
| Propylene conversion (%) | 5.1 |
| Propylene oxide selectivity (%) | 40 |
| STY (μmol-PO/ml-cat · h) | 410 |

### Example B-2

A catalyst was prepared in the same condition as Example B-1 except using 0.52 g of 35% HCl instead of 0.26 g of 35% HCl.

In the catalyst, Cl⁻/Ru molar ratio was 16.8, and the total amount of Cu, Te, Ru and Na was 10.4 weight parts relative to 100 weight parts of SiO₂.

The catalyst was evaluated in the same manners as Example B-1. The results are shown in Table B-2.

TABLE B-2

| | |
|---|---|
| Cl⁻/Ru (molar ratio) | 16.8 |
| Cu/Te/Ru/Na (molar ratio of metal) | 1/0.1/0.5/1.4 |
| Propylene conversion (%) | 5.0 |
| Propylene oxide selectivity (%) | 43 |
| STY (μmol-PO/ml-cat · h) | 435 |

### Comparative Example A-1

A catalyst was prepared in the same condition as Example A-1 except without 69% HNO₃.

In the catalyst, NO₃⁻/Cu molar ratio was 2, and the total amount of Cu, Te, Ru and Na was 10.4 weight parts relative to 100 weight parts of SiO₂.

The catalyst was evaluated in the same manners as Example A-1. The results are shown in Table A-5.

TABLE A-5

| | |
|---|---|
| NO₃⁻/Cu (molar ratio) | 2 |
| Cu/Te/Ru/Na (molar ratio of metal) | 1/0.1/0.5/1.4 |
| Propylene conversion (%) | 4.9 |
| Propylene oxide selectivity (%) | 33 |
| STY (μmol-PO/ml-cat · h) | 333 |

### Comparative Example B-1

A catalyst was prepared in the same condition as Example B-1 except without 35% HCl.

In the catalyst, Cl⁻/Ru molar ratio was 8.8, and the total amount of Cu, Te, Ru and Na was 10.4 weight parts relative to 100 weight parts of SiO₂.

The catalyst was evaluated in the same manners as Example B-1. The results are shown in Table B-3.

TABLE B-3

| | |
|---|---|
| Cl⁻/Ru (molar ratio) | 8.8 |
| Cu/Te/Ru/Na (molar ratio of metal) | 1/0.1/0.5/1.4 |
| Propylene conversion (%) | 4.9 |
| Propylene oxide selectivity (%) | 33 |
| STY (μmol-PO/ml-cat · h) | 333 |

1. A process for preparing a catalyst for production of an olefin oxide comprising (a) a copper oxide and (b) a ruthenium oxide, which comprises the step of
drying a mixture containing a copper component, a ruthenium component, water, and at least one ion selected from the group consisting of a nitrate ion having a molar ratio to the copper of 3 or more and a halide ion having a molar ratio to the ruthenium of 9 or more, and calcining.

2. A process for preparing a catalyst for production of an olefin oxide comprising (a) a copper oxide, (b) a ruthenium oxide and (c) an alkaline metal component or alkaline earth metal component, which comprises the step of
drying a mixture containing a copper component, a ruthenium component, an alkaline metal component or alkaline earth metal component, water, and at least one ion selected from the group consisting of a nitrate ion having a molar ratio to the copper of 3 or more and a halide ion having a molar ratio to the ruthenium of 9 or more, and calcining.

3. A process for preparing a catalyst for production of an olefin oxide comprising (a) a copper oxide, (b) a ruthenium oxide, (c) an alkaline metal component or alkaline earth metal component and (d) a tellurium oxide, which comprises the step of
drying a mixture containing a copper component, a ruthenium component, an alkaline metal component or alkaline earth metal component, a tellurium component, water, and at least one ion selected from the group consisting of a nitrate ion having a molar ratio to the copper of 3 or more and a halide ion having a molar ratio to the ruthenium of 9 or more, and calcining.

4. The process according to claim 1, wherein the mixture contains a support.

5. The process according to claim 2, wherein the mixture contains a support.

6. The process according to claim 3, wherein the mixture contains a support.

7. The process according to claim 4, wherein the support contains Al₂O₃, SiO₂, TiO₂ or ZrO₂.

8. The process according to claim 4, wherein the support contains SiO₂.

9. The process according to claim 1, wherein the ruthenium/copper molar ratio in the catalyst is 0.01/1 to 50/1.

10. The process according to claim 2, wherein the alkaline metal or alkaline earth metal/copper molar ratio in the catalyst is 0.001/1 to 50/1.

11. The process according to claim 3, wherein the tellurium/copper molar ratio in the catalyst is 0.001/1 to 50/1.

12. The process according to claim 1, wherein the component (a) is CuO.

13. The process according to claim 1, wherein the component (b) is RuO₂.

14. The process according to claim 2, wherein the component (c) is an alkaline metal-containing compound.

15. The process according to claim 14, wherein the alkaline metal-containing compound is a sodium-containing compound or a potassium-containing compound.

16. The process according to claim 3, wherein the component (d) contains tellurium and an oxygen atom.

17. The process according to claim 4, wherein the total amount of the components (a) and (b) is 0.01 to 80 weight parts relative to 100 weight parts of the support.

18. The process according to claim 1, wherein the ion is the nitrate ion and the nitrate ion/copper molar ratio is 3 to 50 based on their atoms.

19. The process according to claim 1, wherein the ion is the halide ion and the halide ion/ruthenium molar ratio is 9 to 50 based on their atoms.

20. The process according to claim 1, wherein the ion is the halide ion and the halide ion is Cl⁻.

21. (canceled)

22. (canceled)

23. (canceled)
